(19) United States
(12) Patent Application Publication
(10) Pub. No.: US 2008/0052750 A1
(43) Pub. Date: Feb. 28, 2008

(54) DIRECT-POINT ON-DEMAND INFORMATION EXCHANGES

(76) Inventors: Anders Grunnet-Jepsen, San Jose, CA (US); John Sweetster, San Jose, CA (US); Gopalan Panchanathan, San Jose, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/777,078

(22) Filed: Jul. 12, 2007

Related U.S. Application Data
(60) Provisional application No. 60/840,881, filed on Aug. 28, 2006.

(51) Int. Cl. H04N 7/173

(52) U.S. Cl. 725/109

(57) ABSTRACT

Methods and apparatuses for rapidly tagging and recalling (via direct pointing) metadata from moving or still images are described herein. In one embodiment, data having full descriptions and hyperlinks are tagged to specific objects in moving images and the invisible hyperlinks move dynamically to continually track the associated object. In one embodiment, a pointing device can be used to point to objects in the scene, whether moving or stationary, and by appropriate action such as clicking or activating a button, be able to substantially immediately recall part or all of the metadata content that pertains to the object. Other methods and apparatuses are also described.

### RELATED APPLICATIONS

This application claims the benefit of co-pending U.S. Provisional Application No. 60/840,881, filed Aug. 28, 2006, which is incorporated by reference herein in its entirety.

### FIELD OF THE INVENTION

The present invention relates generally to data processing and information exchange. More specifically it relates to the quick tagging and retrieval of embedded meta-data in multimedia content.

### BACKGROUND

Historically, the advertising industry has searched for ways to become more effective, and commercial advertising has become increasingly invasive. Consequently, consumers have, over the years, developed a strong ambivalence with the advertising industry and its traditional advertising models. On the one hand consumers do recognize many of the inherent benefits to being exposed to advertising, such as the need for being informed about new products that may interest them. They also acknowledge the indirect benefits of being able to receive free services, such as TV or radio shows, at the cost of being exposed to regular advertisements (e.g., commercials every 10 minutes) or continual ads (e.g., banner ads on the internet). However, all these benefits tend to come at the cost of a veritable flood of advertisements that are mostly intrusive, time consuming, and unwanted. The result has been that consumers are adapting to them by either ignoring them, as background noise, or finding clever ways of avoiding them altogether with such tools as time-shifted recordings and commercial skipping (e.g., personal video recorder or PVRs) when watching TV or pop-up blockers on web browsers. In response, the advertising industry is anxiously trying to adapt to these changing patterns by finding new ways to advertise more effectively. Unfortunately, this has, in large part, resulted in the advertising industry becoming even more intrusive by increasing the frequency of the ads, by using clever product placements in shows or by using viral advertising campaigns. The irony in this escalation is that neither side ends up satisfied and the race continues.

Online advertising is not much different despite the wonderful potential for interactivity offered by the internet. Web advertising has instead borrowed almost entirely the mass media advertising model, with very poor results as evidenced by the poor “click-through” rates of, for example, “banner ads”.

Arguably, the most effective advertising model to date, has been the Google Search model whereby the consumer receives a service, i.e. the ability to find something fast that interests him, while being subsequently exposed to general as well as sponsored search results and hyperlinks that are directly applicable to what the user is looking for. This model has the merits of 1) being on-demand, meaning that it is only present when the consumer wants it to be, and 2) being relevant, personalized and targeted to the specific and immediate interests of the consumer. These are the traits that bring users back to the service rather than turn them away. This is a model in which both the consumer and the advertiser benefit. Given the success of this model, the challenge and purpose of this invention is to bring these traits to other media or services.

When examining advertising in media today, it is also important to realize how delivery of media entertainment and content is undergoing a rapid transformation. Traditionally, “TV entertainment” has been enjoyed only in the living room or bedroom in front of the CRT TV. This is no longer true and will become even more archaic in the near future. For example, several companies now offer the ability to transport your TV shows directly from your home to your laptop or desktop PC, to be enjoyed as a small inset window or in full-screen mode. It is even possible to watch shows on mobile phones, PDAs, or mobile media players, such as the iconoclastic IPOD. Entertainment programming can now easily be downloaded or ported via rewritable DVDs or flash memory sticks. In the digital living room, multimedia content may just as easily come from hundreds of TV channels from the cable or satellite box, as from PVRs or online websites. With all this content and digital entertainment in all its forms, a need exists for a tool or service that all consumers/viewers would find beneficial, and which shares the ideal advertising traits exemplified by, for example, the Google Search model.

### SUMMARY OF THE DESCRIPTION

Methods and apparatuses for rapidly tagging and recalling (via direct pointing) metadata from moving or still images are described herein. In one embodiment, data having full descriptions and hyperlinks are tagged to specific objects in moving images and the invisible hyperlinks move dynamically to continually track the associated object. In one embodiment, a pointing device can be used to point to objects in the scene, whether moving or stationary, and, by appropriate action such as clicking or activating a button, substantially immediately recall part or all of the metadata content that pertains to the object.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings.

FIG. 1 shows an example movie scene that will be used to exemplify a video stream that may contain various objects that may or may not be stationary.

FIG. 2 illustrates an example of how the objects in a TV scene may have been uniquely tagged with invisible reference (e.g., “hyperlink”) areas, according to certain embodiments.

FIG. 3 illustrates how a user may use a free-space absolute pointing device to easily point to and select an object in a scene. Note that the tags are not directly visible to the user, according to one embodiment.

FIG. 4 shows the results of such a visual search query according to one embodiment.

FIG. 5 shows an example of a click-history that the user can pull up at his convenience at a later time according to one embodiment.

FIG. 6 shows an example file format for metadata according to one embodiment.

FIG. 7 shows another embodiment of the metadata tagging file format.

FIG. 8 shows one embodiment of the metadata. In one embodiment this metadata is strictly informative and yields results akin to a visual search query according to one embodiment.

### DETAILED DESCRIPTION

Methods and apparatuses for rapidly tagging and recalling metadata from moving or still images are described herein. Embodiments of the present application utilize temporally and/or spatially dynamic object tagging in moving images in conjunction with the use of a pointing device to allow quick access to said information. Embodiments of the present application further provide on-demand advertising where said dynamic metadata and key objects are partially sponsored by paying entities and corporations.

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

According to certain embodiments, an on-demand exchange of information is provided that allows viewers/consumers to interact in real-time with TV programs (or other media content) in order to gather relevant information about selected objects or images in a video scene. For example, a movie scene may present a group of high-society women enjoying coffee on a balcony, when suddenly Brad Pitt brings his red Lamborghini to a screeching halt in front of the appalled women. Consider now being able to point immediately to Brad Pitt's watch and have a cursor on the screen change shape and inform you in a call-out box—“Rolex—$300”, which upon further clicking instantly brings you to a website with the option to buy this watch, or other potentially useful information such as the company website, local vendors, watch types, the history of clocks, etc. Alternatively, pointing to Brad Pitt's head may call up the metadata—“Brad Pitt” with subsequent biographical data being available in the lower half of the screen. Other viewers may be more inclined to point to one of the women's dresses to be informed that this is a “Pierre Cardin blue dress—$299” and a subsequent click may show a list of similar dresses, prices, and locations (both local and online) where they may be bought. Optional features may include the pausing of the show during these information-gathering actions.

This model of embedding and retrieving data clearly fulfills the two key attributes that define a good advertising model: 1) It is an “on-demand” service that fulfills the consumers desire to be informed when and where he wants, while being “invisible” and non-invasive when the consumer wants to just enjoy the show, and 2) it is relevant, personalized and targeted to the specific and immediate interests of the consumer, making it an enriching experience as well as a more efficient means of relevant information exchange.

It is evident with this pointing-based information exchange model that some degree of product placement in the media content may be required. This phenomenon is already becoming widespread. However, it is not an absolute requirement for this model because pointing to a specific object, such as a car, may bring up more generic descriptions of the object that may still lead to sponsored information about similar cars from different vendors as well as more generic information about the object.

There are several technological factors that have converged to make these concepts viable. For one, digital content can now easily carry with it the simple metadata that would be required. With the standard processing power of content players, this metadata can now easily be made to dynamically associate with various objects on the viewer's screen. Second, direct, accurate, and fast pointing, which is a critical element of the implementation and viability of this model, is starting to become widely available. For example, for PC users watching TV at their desk, the computer mouse lends itself very well to quick pointing. For Mobile devices such as Cell Phones and PDAs, touch screens are becoming ever more common and are natural tools for pointing. And finally, for the digital living room, absolute-pointer remote controls, such as vision-based devices, have become available that make pointing as easy, natural, and fast as pointing your finger. This is especially true when the content is displayed on a large, high resolution digital TV screen.

In one embodiment, data having full descriptions and hyperlinks are tagged to specific objects in moving images and the invisible hyperlinks move dynamically to continually track the associated object. In one embodiment, a pointing device can be used to point to objects in the scene, whether moving or stationary, and by appropriate action such as clicking or activating a button, be able to substantially immediately recall part or all of the metadata content that pertains to the object.

In one embodiment, the pointing device is a multi-dimensional free-space pointer where the pointing is direct and absolute in nature, similar to those described in co-pending U.S. patent application Ser. No. 11/187,435, filed Jul. 21, 2005, co-pending U.S. patent application Ser. No. 11/187,405, filed Jul. 21, 2005, co-pending U.S. patent application Ser. No. 11/187,387, filed Jul. 21, 2005, and co-pending U.S. Provisional Patent Application No. 60/831,735, filed Jul. 17, 2006. The disclosure of the above-identified applications is incorporated by reference herein in its entirety.

In one embodiment this metadata is strictly informative and yields results akin to a visual search query such as “What is this that I am pointing at?” In one embodiment, the data is wholly or partially sponsored and paid for to instantiate an on-demand advertising model. In one embodiment, the payment is proportional to the frequency of the searches. In one embodiment, the “point & search” patterns of users are logged for later use in, for example, modifying and tailoring the metadata content.

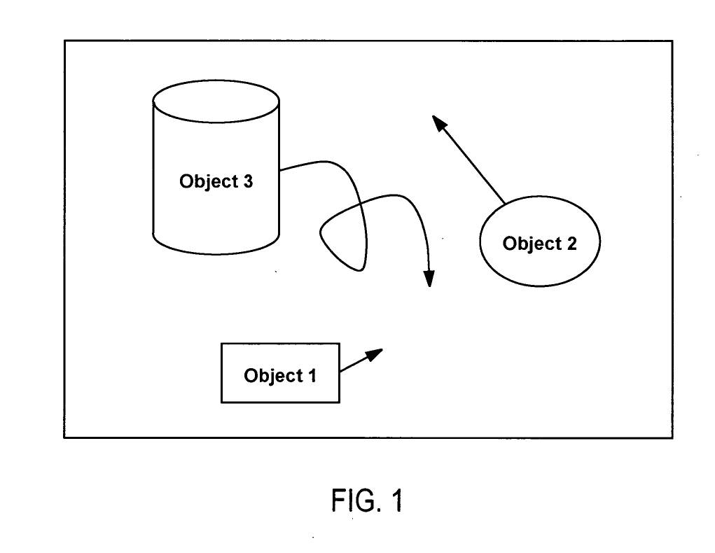

FIG. 1 shows an example movie scene that will be used to exemplify a video stream that may contain various objects that may or may not be stationary. FIG. 1 includes three objects—a rectangle, a ball, and a cylinder that are moving around in the screen and may disappear and re-appear at various locations in space at various times.

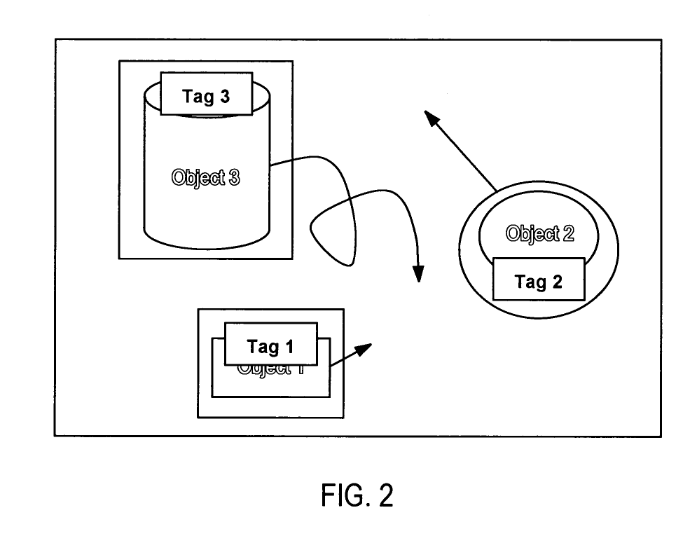

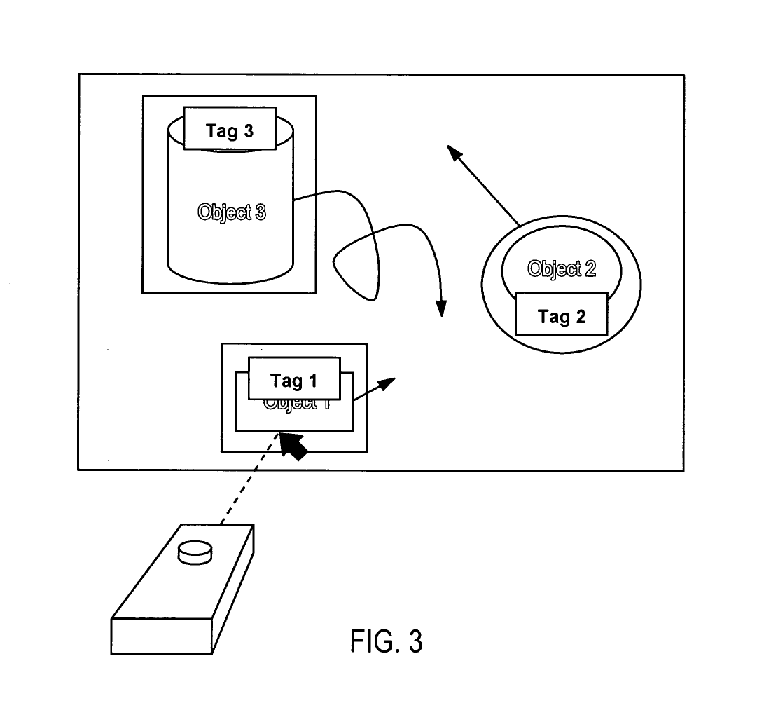

FIG. 2 illustrates an example of how the objects in a TV scene may have been uniquely tagged with invisible reference (e.g., “hyperlink”) areas, according to certain embodiments. Specifically, FIG. 2 shows how the TV scene in FIG. 1 may be over-laid with invisible “tags” or hyperlink areas that move dynamically with the objects they are associated with. The purpose of these invisible tags is to enable a user to point to objects of interest on the screen, as illustrated in FIG. 3 which illustrates how a user may use a free-space absolute pointing device to easily point to and select an object in a scene. Note that the tags are not directly visible to the user, according to one embodiment. In one preferred embodiment the user is sitting in front of a large screen TV using a multi-dimensional absolute pointer, such as the WavIt™ available from ThinkOptics, Inc., described in the above-incorporated co-pending applications, to point to the object of interest.

In one embodiment, a cursor may appear on the screen that changes color and/or shape when a valid tag or hyperlink exists. This feature is similar to that of static hyperlinks that may be embedded in certain web-page images. One difference is that now the tags are dynamically moving with the object, and may grow, shrink, and/or evolve with object size and/or shape, or may disappear and reappear with the object.

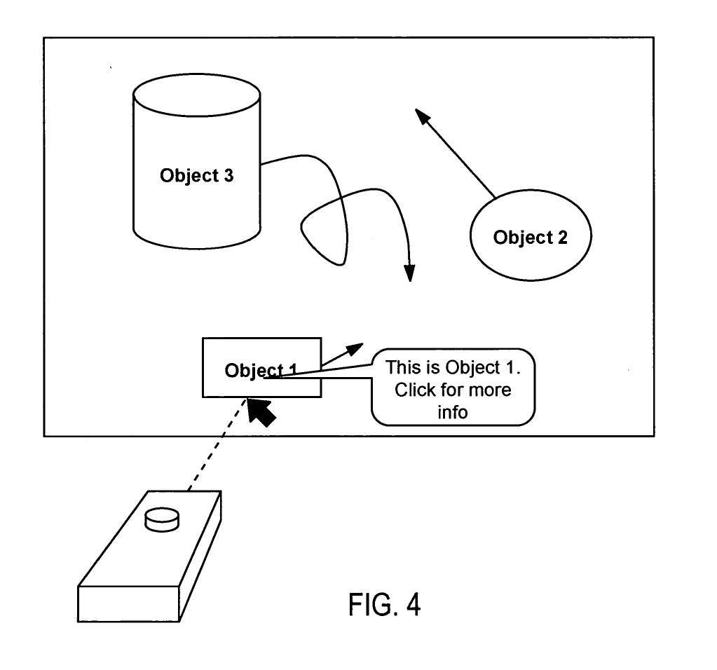

In one embodiment, the object that is pointed to may be selected by pressing a button on a remote control or pointing device. This action may subsequently log the “click” for later retrieval, or in the preferred embodiment it substantially immediately brings up on-screen information about the selected object. FIG. 4 shows the results of such a visual search query according to one embodiment. In an alternative embodiment, instead of pressing a button on the remote control or pointing device, the object may be selected by pointing within the object area or within a predefined range around the area for some predetermined period of time. For example, an object may be selected by pointing at or within a radius of, for example, 50 screen pixels from the center of the object for more than, for example, 2 consecutive seconds. Alternatively, the time required for object selection may depend on the pointing location relative to a reference location within the object area. For example, if the pointed to location is within a certain number, N, of screen pixels of the center of the object, then perhaps only a fraction of a second of continuous pointing within this region may be required for object selection. However, if the pointed to location remains within a number of pixels larger than N, say 2N, then a longer continuous time, say 1 to 2 seconds, may be required before the object is selected. This approach may have advantages especially for rapidly moving objects. Other actions that do not involve pressing a button may also be used for object selection. For example, circling an object with the cursor may be interpreted as object selection.

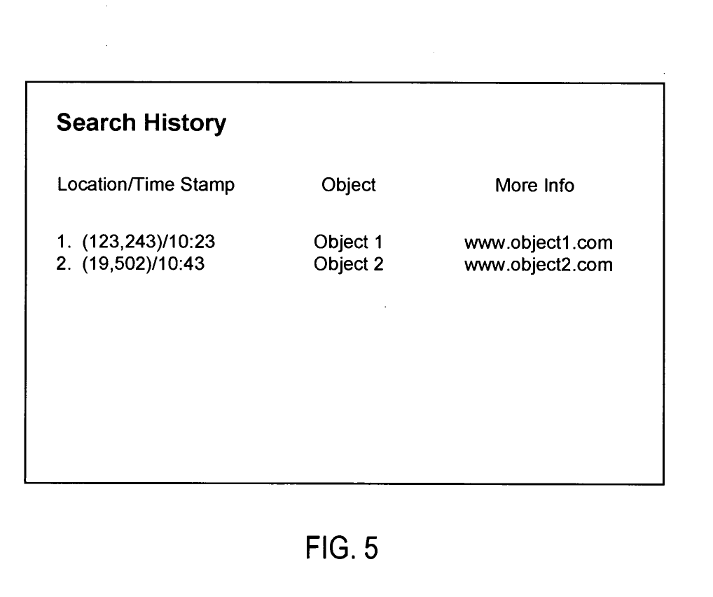

Once an object is selected, some or all of the metadata associated with the object may become immediately visible in, for example, a pop-up graphical representation or menu. Alternatively the object selection may simply be recorded for later viewing. At this point the user may choose to receive more information about the object by, for example, clicking once more inside the call-out bubble. In one embodiment all “clicks” are logged in a click-history that the user can pull up at his convenience at a later time, as illustrated in FIG. 5.

FIG. 5 shows an example click “Search History” screen that may be called up at the user's convenience. This search history may log the location and timestamp of the click as well as the object description and possible further related actions. It is possible to select any of these to jump back to the time and place of the object in the media file, or to examine related information in more detail.

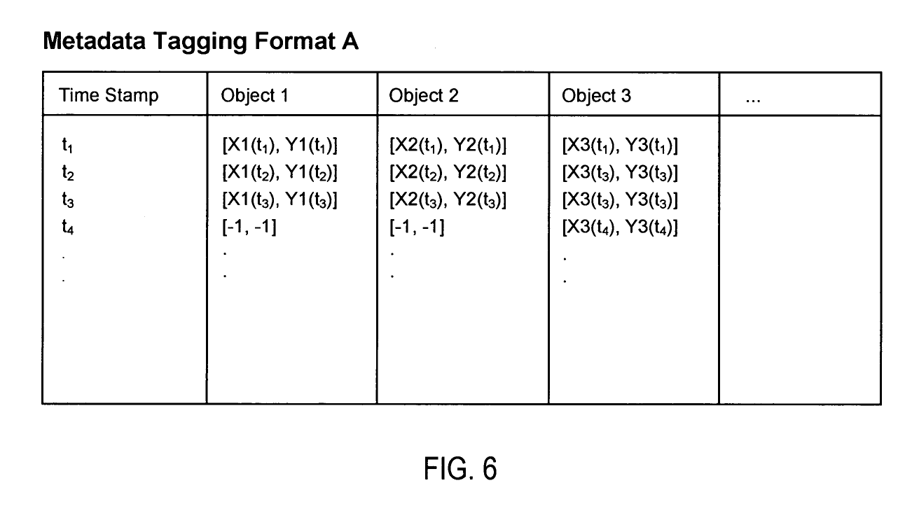

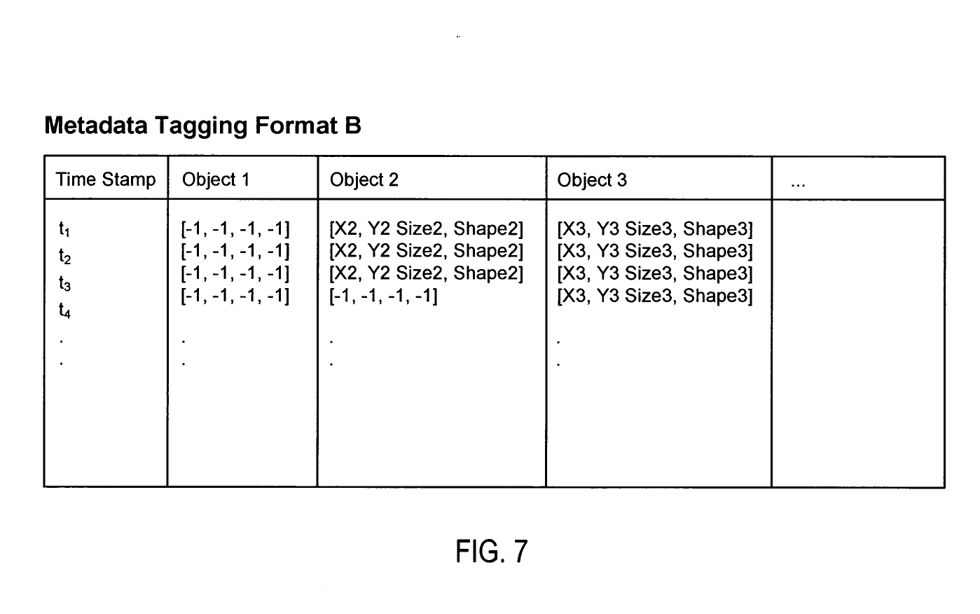

Returning now to the metadata content, it is desirable to the Service Provider that the tagging data be easy to generate, although this is irrelevant to the end user, i.e. the consumer of the service. In one embodiment, the tagging information consists of simple data files that can be specifically generated for different media content. In one embodiment this data consists of arrays of numbers arranged according to the rules laid out in FIG. 6 and FIG. 7.

FIG. 6 shows an example file format for metadata according to one embodiment. It consists of multiple arrays of data for all the potential objects available in the media content. The file contains a first column with incremental timestamps. Corresponding Object columns will contain the specific object's location in space at the corresponding time. If the object is not visible, these columns may contain “−1”.

FIG. 7 shows another embodiment of the metadata tagging file format. The Object columns contain additional data about the size and shape of the Object at the regular incremental time slots.

In one embodiment, the location data is generated by using a software program that allows the Service Provider to run the media content one or more times while pointing to the objects of interest. If, for example, the Service Provider simultaneously holds down specific keys on a keyboard that correspond to that object, the object's position is recorded (overwritten) in the corresponding object column. While the object is not visible on the screen, no key will be pressed and hence the default value of −1 will remain in the object column, signifying that the object is not present.

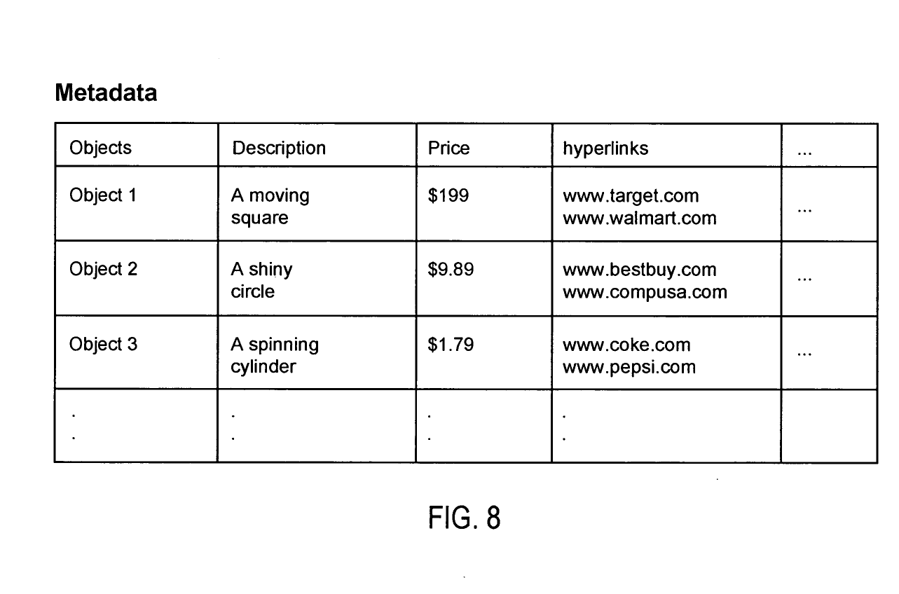

Having discussed embodiments for how different objects moving around in video content may be easily tagged with time and location stamps and stored in “tagging” files, it is useful to discuss the actual descriptive metadata itself. FIG. 8 shows one embodiment of the metadata. In one embodiment this metadata is strictly informative and yields results akin to a visual search query such as “What is this that I am pointing at?”. In one embodiment, the data is wholly or partially sponsored and paid for to instantiate an on-demand advertising model. Objects may have multiple sponsors. For example a generic “soda can” may be sponsored by Coke and Pepsi. Tiered pricing may also be offered to change the search ranking results. In one embodiment said payment is proportional to the recorded frequency of said visual searches, yielding a “click-model” for advertising.

FIG. 8 shows an example of metadata content. This metadata content may apply to different video files. By contrast the “tagging files” are specific to each file. In one embodiment all metadata and tagging data information accompanies the video media, such as the DVD or movie MPEG file. In one preferred embodiment all of this data resides on the internet. In this case software on the media player may recognize content being viewed, for example from its title, and download the appropriate metadata and tagging file. This embodiment permits more flexibility for the Service Provider to modify and update the files as appropriate. In one embodiment, the metadata relates to direct marketing information and the visual search described in this disclosure can be used as a tool for order generation, voting, subscriptions, coupons, vouchers, direct sales, etc.

Thus, methods and apparatuses for rapidly tagging and recalling (via direct pointing) metadata from moving or still images have been described herein. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer implemented method, comprising:
associating metadata with an object of a media stream having one or more frames, the metadata having information describing the object, including a location of the object within each frame;
dynamically tracking a pointed to location of a pointing device having a free-space multi-dimensional absolute pointer when a particular frame of the media stream is displayed; and
in response to an activation of the pointing device when the pointed to location of the pointing device is within a predetermined proximity of the object, retrieving and presenting the information from the metadata associated with the object.

2. The method of claim 1, further comprising providing metadata for the object for each frame of the media stream prior to displaying the media stream, wherein the metadata is invisible to a viewer of the media stream.

3. The method of claim 2, wherein the media stream comprises a digital movie.

4. The method of claim 1, wherein the metadata of the object further includes a hyperlink which when the activation of the pointing device is detected, additional information is retrieved and displayed from a remote facility via the hyperlink.

5. The method of claim 4, wherein the metadata of the object further comprises a description about the object and a cost to purchase the object from the remote facility.

6. The method of claim 5, wherein the metadata of the object comprises multiple hyperlinks and wherein different information is retrieved from multiple remote facilities via the hyperlinks to enable a viewer to compare the retrieved information.

7. The method of claim 1, further comprising determining the coordinates of the pointing device based on an orientation and/or location of the pointing device with respect to one or more reference markers located at a fixed location with respect to the display area.

8. The method of claim 7, wherein the pointing device includes a pixelated sensor and a wireless transceiver wirelessly communicating with a receiver that is connected to the display, and wherein the pointing device calculates its orientation and/or location based on information from the pixelated sensor.

9. The method of claim 8, wherein the pointing device wirelessly transmits the calculated orientation and/or location to the receiver to enable a controller coupled to the receiver to determine an absolute location pointed to by the pointing device within the display area.

10. A machine-readable medium having instructions stored therein, which when executed by a processor, cause the processor perform a method, the method comprising:
associating metadata with an object of a media stream having one or more frames, the metadata having information describing the object, including a location of the object within each frame;
dynamically tracking a pointed to location of a pointing device having a free-space multi-dimensional absolute pointer when a particular frame of the media stream is displayed; and
in response to an activation of the pointing device when the pointed to location of the pointing device is within a predetermined proximity of the object, retrieving and presenting the information from the metadata associated with the object.

11. The machine-readable medium of claim 10, wherein the method further comprises providing metadata for the object for each frame of the media stream prior to displaying the media stream, wherein the metadata is invisible to a viewer of the media stream.

12. The machine-readable medium of claim 11, wherein the media stream comprises a digital movie.

13. The machine-readable medium of claim 10, wherein the metadata of the object further includes a hyperlink which when the activation of the pointing device is detected, additional information is retrieved and displayed from a remote facility via the hyperlink.

14. The machine-readable medium of claim 13, wherein the metadata of the object further comprises a description about the object and a cost to purchase the object from the remote facility.

15. The machine-readable medium of claim 14, wherein the metadata of the object comprises multiple hyperlinks and wherein different information is retrieved from multiple remote facilities via the hyperlinks to enable a viewer to compare the retrieved information.

16. The machine-readable medium of claim 10, wherein the method further comprises determining the coordinates of the pointing device based on an orientation and/or location of the pointing device with respect to one or more reference markers located at a fixed location with respect to the display area.

17. The machine-readable medium of claim 16, wherein the pointing device includes a pixelated sensor and a wireless transceiver wirelessly communicating with a receiver that is connected to the display, and wherein the pointing device calculates its orientation and/or location based on information from the pixelated sensor.

18. The machine-readable medium of claim 17, wherein the pointing device wirelessly transmits the calculated orientation and/or location to the receiver to enable a controller coupled to the receiver to determine an absolute location pointed to by the pointing device within the display area.

19. A data processing system, comprising:
a processor; and
a memory for storing instructions, which when executed from the memory, cause the processor to perform a method, the method including
associating metadata with an object of a media stream having one or more frames, the metadata having information describing the object, including a location of the object within each frame,
dynamically tracking a pointed to location of a pointing device having a free-space multi-dimensional absolute pointer when a particular frame of the media stream is displayed, and
in response to an activation of the pointing device when the pointed to location of the pointing device is within a predetermined proximity of the object, retrieving and presenting the information from the metadata associated with the object.

20. The system of claim 19, wherein the method further comprises providing metadata for the object for each frame of the media stream prior to displaying the media stream, wherein the metadata is invisible to a viewer of the media stream.
